(19) United States
(12) Patent Application Publication
(10) Pub. No.: US 2026/0235722 A1
(43) Pub. Date: Aug. 13, 2026

(54) THRESHOLD ADJUSTMENT METHOD, PROCESSING DEVICE, AND ELECTRONIC DEVICE

(71) Applicant: WNC Corporation, HSINCHU (TW)

(72) Inventors: GUAN-SIAN WU, HSINCHU (TW); CHIA-CHUAN CHAO, HSINCHU (TW)

(21) Appl. No.: 19/531,924

(22) Filed: Feb. 6, 2026

(30) Foreign Application Priority Data
Feb. 12, 2025 (TW) 114105097

(51) Int. Cl. G01S 7/292; G01S 7/35; G01S 13/42; H04N 7/18

(52) U.S. Cl. CPC G01S 7/2922; G01S 7/354; G01S 13/426; H04N 7/188

(57) ABSTRACT

A threshold adjustment method, a processing device, and an electronic device. The preset threshold table stores a plurality of preset threshold corresponding to different coordinates in a preset range. When a radar scanner is in a second mode, the processor is configured to generate a scanning result based on radar echo data entries generated by the radar scanner and the corresponding preset threshold, and determine whether the scanning result corresponds to a switching condition. When the scanning result corresponds to the switching condition, the processor further determines whether the scanning result corresponds to a preset ignore state; if it is determined that the scanning result corresponds to the preset ignore state, at least one threshold value in the preset threshold table is modified. Next, the radar scanner is switched to a first mode.

### CROSS-REFERENCE TO RELATED PATENT APPLICATION

This application claims the benefit of priority to Taiwan Patent Application No. 114105097, filed on Feb. 12, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a threshold adjustment method, a processing device, and an electronic device, and more particularly, to a threshold adjustment method executed by a processor of a radar scanning module, a processing device capable of executing the threshold adjustment method, and an electronic device containing a radar scanning module.

### BACKGROUND OF THE DISCLOSURE

Conventional smart doorbells with radar scanning modules commonly trigger alerts or activate image capture devices upon detecting situations such as tree swaying. Such designs not only cause inconvenience to users but also waste the doorbell's power.

### SUMMARY OF THE DISCLOSURE

In one aspect, the present disclosure provides a threshold adjustment method executed by a processor of a radar scanning module when a radar scanner of the radar scanning module operates in a second mode. The processor controls the radar scanner to switch between a first mode and the second mode, and the radar scanner is configured to scan a preset range to generate a plurality of radar echo data entries. The processor pre-stores a preset threshold table in a storage unit (e.g., memory), and the preset threshold table storing a plurality of preset thresholds respectively corresponding to different coordinates within the preset range. The threshold adjustment method includes the following steps: a mode switching determination step: generating a scanning result based on the plurality of radar echo data entries and at least one of the plurality of preset thresholds, and determining whether the scanning result corresponds to a switching condition; in response to determining that the scanning result corresponds to the switching condition, execute the following steps: a threshold adjustment determination step: determining whether the scanning result corresponds to a preset ignore state; in response to determining that the scanning result corresponds to the preset ignore state, modifying at least one threshold in the preset threshold table; and a switching step: switching the radar scanner to the first mode.

In another aspect, the present disclosure provides a processing device, which includes a processor capable of executing the threshold adjustment method of the present disclosure.

In yet another aspect, the present disclosure provides an electronic device, which includes a processor and a radar scanner. The processor is capable of executing the threshold adjustment method of the present disclosure.

In summary, the threshold adjustment method, processing device, and electronic device of the present disclosure, through the design of the mode switching determination step, the threshold adjustment determination step, and the switching step, can make the radar scanner less likely to frequently switch between the first mode and the second mode due to objects that do not need to be tracked, thereby effectively reducing the overall power consumption of the electronic device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of an electronic device according to the present disclosure;

FIG. 2 is a flow chart of a threshold adjustment method according to a first embodiment of the present disclosure;

FIG. 3 is a flow chart of the threshold adjustment method according to a second embodiment of the present disclosure;

FIG. 4 is a flow chart of the threshold adjustment method according to a third embodiment of the present disclosure;

FIG. 5 is a flow chart of the threshold adjustment method according to a fourth embodiment of the present disclosure;

FIG. 6 is a schematic diagram illustrating an establishment of an adjusted region in a threshold adjustment step in FIG. 5;

FIG. 7 is a flow chart of the threshold adjustment method according to a fifth embodiment of the present disclosure;

FIG. 8 is a flow chart of the threshold adjustment method according to a sixth embodiment of the present disclosure;

FIG. 9 is a flow chart of the threshold adjustment method according to a seventh embodiment of the present disclosure;

FIG. 10 is a flow chart of the threshold adjustment method according to an eighth embodiment of the present disclosure; and

FIG. 11 is a flow chart of the threshold adjustment method according to a ninth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

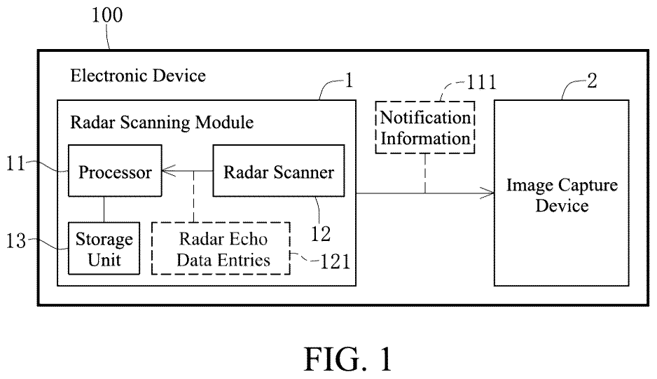

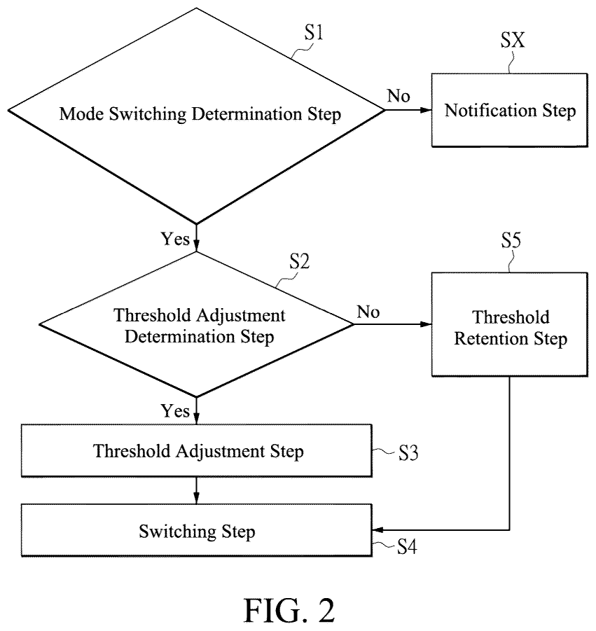

Referring to FIG. 1 and FIG. 2. FIG. 1 is a block diagram of an electronic device of the present disclosure, and FIG. 2 is a flow chart of the threshold adjustment method according to a first embodiment of the present disclosure. As shown in FIG. 1, the electronic device 100 of the present disclosure includes: a radar scanning module 1 and an image capture device 2. The radar scanning module 1 includes a processor 11, a radar scanner 12, and a storage unit 13. The processor 11 is electrically connected to the radar scanner 12 and the storage unit 13. After the radar scanner 12 scans a preset range, it will generate a plurality of radar echo data entries 121, and the processor 11 receives the plurality of radar echo data entries 121. The storage unit 13 pre-stores a preset threshold table, and the preset threshold table stores and is used to indicate a plurality of preset thresholds corresponding to different coordinates within the preset range. In one embodiment, the preset thresholds included in the preset threshold table may be different values depending on requirements. That is, in the preset threshold table, different coordinate positions in the preset range may have different thresholds. In a specific embodiment, the electronic device 100 may be a doorbell, but the present disclosure is not limited thereto.

In practice, after the processor 11 receives the plurality of radar echo data entries 121, the processor 11 may, for example, perform calculations such as Fast Fourier Transform (FFT) and constant false alarm rate (CFAR) on the radar echo information to generate at least point cloud data entries. The method of converting radar echo information into point cloud information is known technology and is therefore not described herein. Each point cloud data entry includes at least a coordinate, a distance (Radius), a signal strength, a signal-to-noise ratio (SNR), or an azimuth/elevation angle or a combination thereof.

The preset threshold table is used by the processor 11 to determine whether an object to be tracked appears in the preset range. Specifically, after obtaining the radar echo information, the processor 11 looks up, based on a coordinate included in the radar echo information, a corresponding preset threshold in the preset threshold table, and determine whether the signal strength of the radar echo information is greater than the looked-up preset threshold. If the signal strength is greater than the looked-up preset threshold, the processor 11 determines that an object to be tracked appears at the position within the preset range corresponding to the coordinate.

It should be noted that the closer the position of the object within the preset range is to the radar scanner 12, the greater the signal strength corresponding to the radar echo information received by the processor 11; conversely, the farther the position of the object within the preset range is from the radar scanner 12, the smaller the signal strength corresponding to the radar echo information received by the processor 11. Therefore, in order to allow the processor to more accurately determine whether an object to be tracked appears in the preset range, in practice, the preset threshold corresponding to a position in the preset range that is farther from the radar scanner 12 can be smaller in the preset threshold table; and the preset threshold corresponding to a position in the preset range that is closer to the radar scanner 12 can be larger in the preset threshold table. However, the present disclosure is not limited thereto. For example, in other embodiments of the present disclosure, the corresponding preset thresholds the preset threshold table may be adjusted according to actual design requirements.

In one embodiment, when the radar scanner 12 operates in the first mode, it scans the preset range at intervals of a first time period. When the radar scanner 12 operates in the second mode, it scans the preset range at intervals of a second time period. The first time period is longer than the second time period. For example, when the radar scanner 12 is in the first mode, it scans the preset range once every 1000 milliseconds. When the radar scanner 12 is in the second mode, it scans the preset range once every 100 milliseconds. In other words, for the same duration, the radar scanner 12 operating in the second mode consumes more energy than when operating in the first mode. In one embodiment, when the radar scanner 12 is in the first mode and the second mode, it may scan the preset range in a low-resolution manner and a high-resolution manner, respectively.

The processor 11 controls the radar scanner 12 to switch between the first mode and the second mode. When the radar scanner 12 is in the second mode, after the radar scanner 12 scans the preset range, it will generate the plurality of radar echo data entries, and the processor 11 receives the plurality of radar echo data entries and executes the threshold adjustment method of the present disclosure.

In practice, when the radar scanner 12 is in the first mode, if the processor 11 determines that the object to be tracked appears in the preset range based on the radar echo information transmitted by the radar scanner 12, the processor will control the radar scanner 12 to switch to the second mode.

The threshold adjustment method of the present disclosure includes the following steps:

A mode switching determination step S1: generate a scanning result based on a plurality of radar echo data entries and at least one preset threshold, and determine whether the scanning result corresponds to a switching condition.

If it is determined that the scanning result corresponds to the switching condition, the processor executes the following steps:

A threshold adjustment determination step S2: determine whether the scanning result corresponds to a preset ignore state.

If it is determined that the scanning result corresponds to the preset ignore state, the processor 11 executes the following step:

A threshold adjustment step S3: modify at least one preset threshold in the preset threshold table.

A switching step S4: switch the radar scanner 12 to the first mode.

If it is determined that the scanning result does not correspond to the preset ignore state, the processor 11 executes a threshold retention step S5: no modification to the preset thresholds in the preset threshold table. In other words, the preset thresholds stored in the preset threshold table are maintained without modification.

In practical applications, in the mode switching determination step S1, the processor 11 first converts each radar echo data entries into point cloud data entries, then uses the coordinates in the point cloud data entries to look up the corresponding preset thresholds in the preset threshold table, and determines whether the signal strength in the point cloud data entries is greater than the preset threshold. If it is greater than the preset threshold, an object to be tracked is established using that point cloud data entries. After establishing the corresponding object to be tracked using the plurality of radar echo data entries to, the processor can generate a movement trajectory of the object to be tracked based on the positions of the object to be tracked, and the movement trajectory constitutes the scanning result.

Following the above, after establishing the movement trajectory of the object to be tracked in the mode switching determination step S1, the processor 11 can determine whether the movement trajectory of the object to be tracked matches one of a plurality of preset trajectories. If the processor 11 determines that the movement trajectory does not match any one of the preset trajectories, the processor 11 determines that the scanning result corresponds to the switching condition. Conversely, the processor 11 determines that the scanning result does not correspond to the switching condition.

In the example where the electronic device 100 is applied as a doorbell, one of the preset trajectories may correspond to approaching or walking towards the doorbell. That is, in the example where the electronic device 100 is a doorbell, when the processor 11 is in the second mode and executes the mode switching determination step S1, if the processor 11 determines, based on the radar echo information, that an object walking towards the doorbell appears within the preset range in front of the doorbell, the processor 11 determines that the scanning result does not correspond to the switching condition, and the processor 11 does not cause the radar scanner 12 to switch to the first mode, so that the radar scanner remains in the second mode. Conversely, if the processor 11 determines, based on the radar echo information, that no object matching any of the preset trajectories appears within the preset range in front of the doorbell, the processor 11 determines that the scanning result corresponds to the switching condition and proceeds to execute the threshold adjustment determination step S2.

As described above, in the mode switching determination step S1, if the scanning result corresponds to the switching condition, it indicates that the movement trajectory of the object to be tracked does not match any of the plurality of preset trajectories. If the scanning result does not correspond to the switching condition, it indicates that the movement trajectory of the object to be tracked matches one of the plurality of preset trajectories, and the processor then executes a notification step SX: send a notification information 111 to the image capture device 2 to activate the image capture device 2. After the image capture device 2 is activated, the image capture device 2, for example, takes photographs or make video recording of the preset range.

In an embodiment in which the electronic device 100 does not include the image capture device 2, in the notification step SX, the processor 11 sends the notification information 111 to a preset external image capture device. After receiving the notification information 111, the external image capture device takes photograph and/or make video recording of the preset range.

In practical applications, in the threshold adjustment determination step S2, the preset ignore state may be that the movement distance of the object to be tracked within a preset time period is less than a preset distance, i.e., the movement distance corresponding to the movement trajectory is less than the preset distance. For example, suppose that a tree swaying due to wind appears in the preset range and the swaying distance of the tree is less than the preset distance. Then, in the mode switching determination step S1, the processor determines that the movement trajectory of the object to be tracked (the tree) appearing within the preset range does not match any of the preset trajectories, and proceeds to the threshold adjustment determination step S2. In the threshold adjustment determination step S2, the processor 11 determines that the scanning result corresponds to the preset ignore state because the movement distance of the tree is less than the preset distance.

In practical applications, in the threshold adjustment step S3, the method of modifying the preset thresholds in the preset threshold table is to modify at least one preset threshold in the preset threshold table to a new threshold. The value of the new threshold is greater than the value of the corresponding preset threshold. A threshold-adjusted region jointly formed by a plurality of coordinates corresponding to a plurality of new thresholds covers at least a part of the activity range of the object to be tracked within the preset time period. That is, at least a portion of the thresholds in the preset threshold table corresponding to the activity range of the object to be tracked within the preset time period will be modified to new thresholds.

In practice, after the radar scanner 12 switches to the first mode, the radar scanner 12 continuously generates radar echo information. After the processor receives the radar echo information, it uses the coordinates and signal strength in the radar echo information and the current preset threshold table to determine whether an object to be tracked appears in the preset range. When the processor determines that the signal strength in the radar echo information is less than the corresponding preset threshold in the preset threshold table, the processor determines that an object to be tracked does not appear within the preset range. Conversely, if the processor determines, based on the radar echo information, that an object to be tracked appears, the processor causes the radar scanner to switch to the second mode, and the processor then executes the threshold adjustment method of the present disclosure.

Continuing with the tree example, after the processor 11 completes the threshold adjustment step S3 and the switching step S4 and the radar scanner 12 switches to the first mode, the thresholds in the current preset threshold table corresponding to the tree positions have already been modified to new thresholds. Therefore, when the processor obtains the signal strengths corresponding to the tree positions from the radar echo information, it determines that no object to be tracked appears within the preset range at the positions corresponding to the trees because the signal strengths are less than the new thresholds. As a result, the processor does not cause the radar scanner to switch to the second mode due to trees in the preset range being swayed by wind.

As described above, through the design of the mode switching determination step S1, the threshold adjustment determination step S2, and the threshold adjustment step S3, the radar scanner 12 will not frequently switch between the first mode and the second mode due to an object existing in the preset range that does not need to be tracked (for example, the tree swaying due to wind), thereby reducing the power consumption of the radar scanner 12.

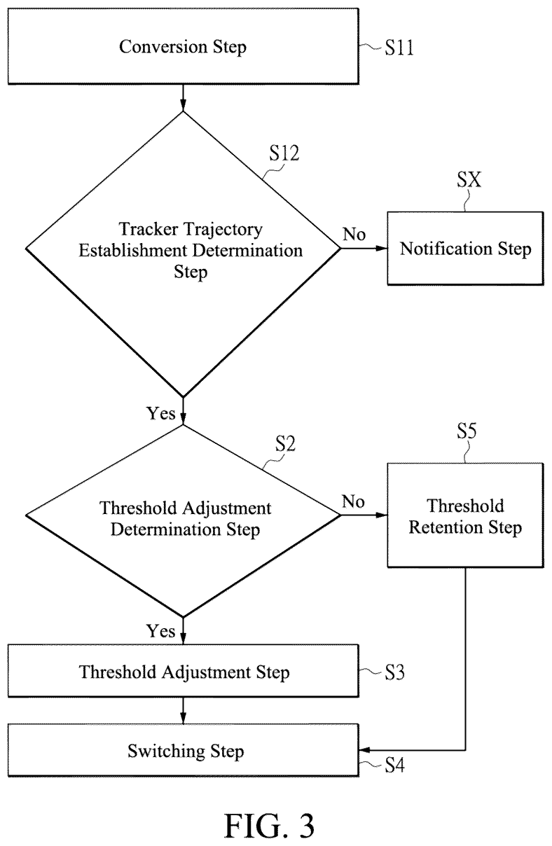

Referring to FIG. 3, which shows a flow chart of the threshold adjustment method according to a second embodiment of the present disclosure. The difference between the threshold adjustment method of this embodiment and the first embodiment lies in that: in the mode switching determination step S1, the following steps are executed:

A conversion step S11: convert a plurality of radar echo data entries into a plurality of point cloud data entries.

A tracker trajectory establishment determination step S12: use a plurality of point cloud data entries to establish an object to be tracked and determine whether the movement trajectory of the object to be tracked matches one of the plurality of preset trajectories.

If it is determined that the movement trajectory matches, the notification step SX is executed.

If it is determined that the movement trajectory does not match, the threshold adjustment determination step S2 is executed.

It should be noted that when the radar scanner 12 is in the second mode, the radar scanner 12 continuously scans the preset range at intervals of a second preset time to continuously generate radar echo data entries 121, and the processor 11 continuously receives the radar echo data entries 121 transmitted by the radar scanner 12. Since the processor 11 continuously receives the radar echo data entries 121, the processor 11 continuously converts the radar echo data entries 121 into multiple pieces of point cloud information and uses the multiple pieces of point cloud information to establish an object to be tracked. In the tracker trajectory establishment determination step S12, the processor 11 uses the positions of the object to be tracked established before and after to generate the trajectory of the object to be tracked. The method for establishing the movement trajectory of the object to be tracked is known technology and is therefore not described herein.

In practice, when the processor 11 determines in the tracker trajectory establishment determination step S12 that the movement trajectory of the object to be tracked does not match any preset trajectory, it may indicate that the object to be tracked is stationary, the movement amplitude of the object to be tracked is small, the object to be tracked disappears, or the object to be tracked moves but does not belong to any preset trajectory.

In practical applications, the radar scanning module 1 includes a hardware accelerator, which is mainly used to accelerate the processor 11 in executing the above conversion step S11, the tracker trajectory establishment determination step S12, and the work of establishing objects to be tracked using multiple pieces of point cloud information. Specifically, the hardware accelerator includes a computation chip designed to specifically execute the above steps. Through the design of the hardware accelerator, the overall response speed and operating efficiency of the electronic device can be improved.

In one embodiment, in the tracker trajectory establishment determination step S12, the processor 11 uses an Extended Kalman Filter (EKF) to generate object to be tracked.

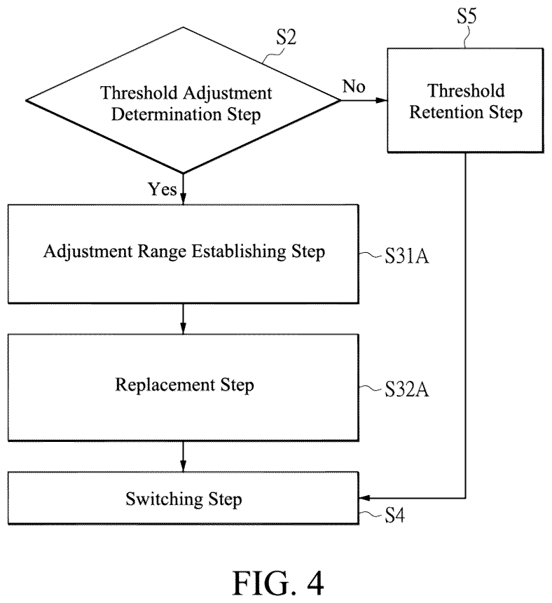

Referring to FIG. 4, which shows a flow chart of the threshold adjustment method according to a third embodiment of the present disclosure. In the figure of this embodiment, the flow steps prior to the threshold adjustment determination step S2 are the same as those of the second embodiment, and therefore are omitted in the figure.

In the threshold adjustment step S3, the following steps are executed:

An adjustment range establishing step S31A: establish a point cloud-adjusted region having a preset area using the point cloud coordinates of each point cloud data entry.

A replacement step S32A: based on the point cloud-adjusted region, modify at least one preset threshold to a new threshold greater than the corresponding original threshold in the preset threshold table. It should be noted that each preset threshold to be modified refers to a preset threshold less than the signal strength in the point cloud data entries, that is, a threshold located in the point cloud-adjusted region but greater than the signal strength is not a preset threshold to be modified.

Table 1 and Table 2 are illustrations of a preset threshold table pre-stored in the storage unit and a modified preset threshold table, respectively. In Tables 1 and 2, the values in the first row represent Y-axis coordinate values, the values in the first column represent X-axis coordinate values, and the value in each cell in the table represents the corresponding threshold at a specific (X, Y) coordinate. For example, in Table 1, the threshold corresponding to coordinate (1,1) is 19.208, and the threshold corresponding to coordinate (3,4) is 7. The thresholds corresponding to the respective coordinates in the preset threshold table can be designed according to actual needs. Table 1 only shows one exemplary form.

As shown in Table 1, suppose that in the mode switching determination step S1, the processor 11 determines that a point cloud data entries appears within the preset range, and that in the adjustment range establishing step S31A, the processor 11 determines that the point cloud coordinate of the point cloud data entries corresponds to the coordinate (3,4) in the preset threshold table. Then, the preset threshold corresponding to the point cloud data entries in the preset threshold table is 7. The method by which the processor 11 converts the point cloud coordinates to the coordinates of the preset threshold table is known technology and is therefore not described herein.

Continuing with the above example, as shown in Table 2 below, suppose that the preset area is 9 square units in the adjustment range establishing step S31A. Then, in the adjustment range establishing step S31A, the processor 11 will expand by one cell to the surrounding area with coordinate (3,4) as the center, to establish the point cloud-adjusted region. The preset area of the point cloud-adjusted region is thus 9 square units. In the replacement step S32A, at least one threshold located in the point cloud-adjusted region in the preset threshold table shown in Table 1 will be modified to a new threshold greater than the corresponding original threshold.

Specifically, suppose that the signal strength of the point cloud data entries is 7.25. Then, in the replacement step S32A, the processor 11 may modify only the thresholds corresponding to coordinates within the point cloud-adjusted region whose thresholds are less than 7.25. In other words, in the preset threshold table shown in Table 1, since the thresholds corresponding to coordinates (2,4), (2,5), (3,4), (3,5), and (4,5) are all less than 7.25, while the thresholds corresponding to coordinates (2,3), (3,3), (4,3), and (4,4) are all greater than 7.25, the processor 11 modifies only the thresholds corresponding to coordinates (2,4), (2,5), (3,4), (3,5), and (4,5) to the new thresholds in the replacement step S32A, and the processor 11 does not modify the thresholds corresponding to coordinates (2,3), (3,3), (4,3), and (4,4).

TABLE 1

| | X | | | | | |
|---|---|---|---|---|---|---|
| Y | 1 | 2 | 3 | 4 | 5 | 6 |
| 1 | 19.208 | 19.208 | 19.208 | 19.208 | 19.208 | 19.208 |
| 2 | 19.208 | 19.208 | 19.208 | 19.208 | 19.208 | 19.208 |
| 3 | 19.208 | 19.208 | 19.208 | 19.208 | 19.208 | 19.208 |
| 4 | 7 | 7 | 7 | 19.208 | 19.208 | 19.208 |
| 5 | 7 | 7 | 7 | 7 | 19.208 | 19.208 |
| 6 | 7 | 7 | 7 | 7 | 7 | 19.208 |

TABLE 2

| | X | | | | | |
|---|---|---|---|---|---|---|
| Y | 1 | 2 | 3 | 4 | 5 | 6 |
| 1 | 19.208 | 19.208 | 19.208 | 19.208 | 19.208 | 19.208 |
| 2 | 19.208 | 19.208 | 19.208 | 19.208 | 19.208 | 19.208 |
| 3 | 19.208 | 19.208 | 19.208 | 19.208 | 19.208 | 19.208 |
| 4 | 7 | 9.25 | 9.25 | 19.208 | 19.208 | 19.208 |
| 5 | 7 | 9.25 | 9.25 | 9.25 | 19.208 | 19.208 |
| 6 | 7 | 7 | 7 | 7 | 7 | 19.208 |

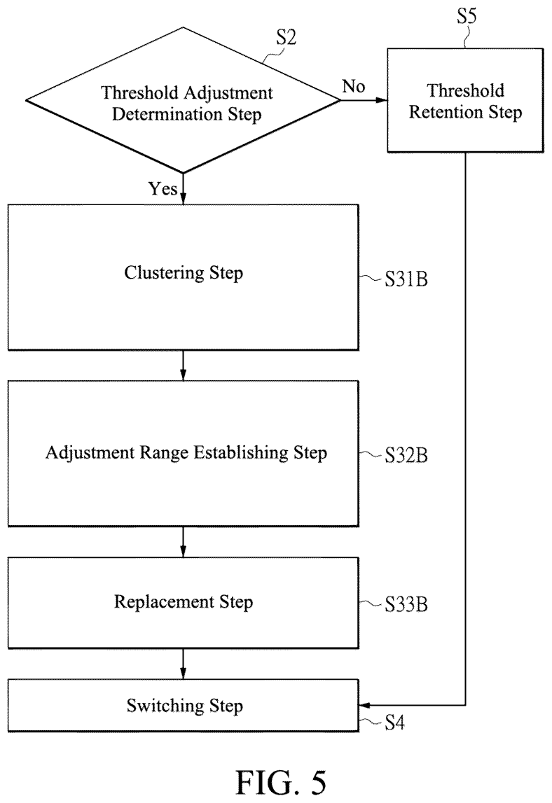

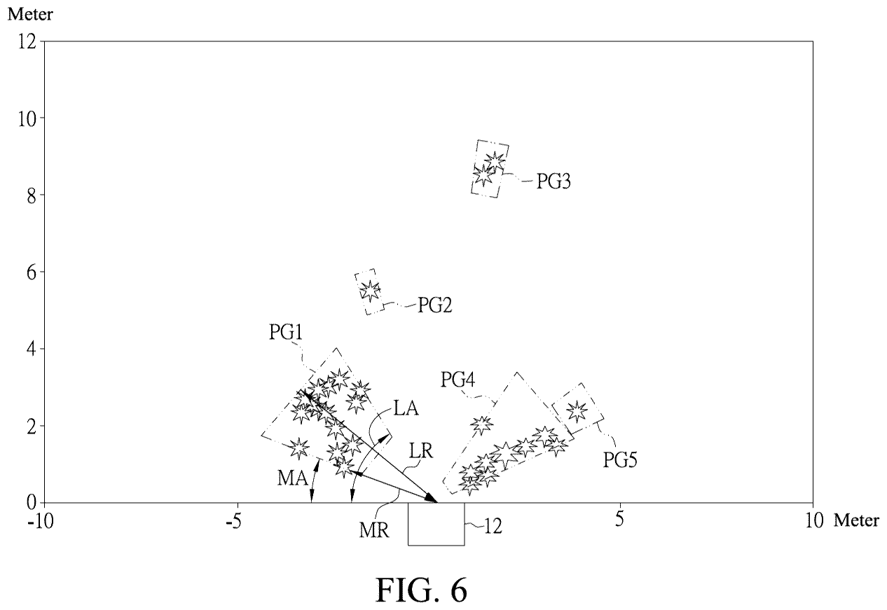

Referring to FIG. 5 and FIG. 6. FIG. 5 shows a flow chart of the threshold adjustment method according to the fourth embodiment of the present disclosure, and FIG. 6 shows a schematic diagram of the adjustment in the threshold adjustment step of FIG. 5. In this embodiment, the flow steps prior to the threshold adjustment determination step S2 are the same as those of the third embodiment, and therefore are omitted in the figure.

In this embodiment, the conversion step S11 (as shown in FIG. 3) converts a plurality of radar echo data entries 121 into a plurality of point cloud data entries. Each point cloud data entry includes at least a point cloud coordinate and a signal parameter. In the threshold adjustment step S3, the following steps are executed:

A clustering step S31B: classify the plurality of point cloud coordinates into a plurality of point cloud groups based on the distances between the plurality of point cloud coordinates; a linear distance between the plurality of point cloud coordinates located in the same point cloud group is less than a preset distance.

An adjustment range establishing step S32B: establish a point cloud-adjusted region based on the linear distances between each point cloud coordinate in each point cloud group and the radar scanner 12; all point cloud coordinates in the same point cloud group are located in the same point cloud-adjusted region.

A replacement step S33B: based on the point cloud-adjusted region, modify at least one preset threshold to a new threshold in the preset threshold table.

As shown in FIG. 6, which shows a distance relationship between point cloud information and the radar scanner. The X-axis and Y-axis in the figure respectively represent distances, and each pattern shown in the figure represents one item of point cloud information. The circled region in the figure represents the preset range. In the example shown in FIG. 6, in the clustering step S31B, the processor 11 classifies/groups a plurality of point cloud coordinates into a first point cloud group PG1, a second point cloud group PG2, a third point cloud group PG3, a fourth point cloud group PG4, and a fifth point cloud group PG5 based on linear distances between the point cloud coordinates. In one example, the processor may use a Density-Based Spatial Clustering of Applications with Noise (DBSCAN) algorithm to cluster the plurality of point cloud data entries. In other words, adjacent point cloud data entries are classified by the processor into the same point cloud group.

As such, after the processor clusters the plurality of point cloud data entries, in the adjustment range establishing step S32B, the processor establishes the point cloud-adjusted region corresponding to each point cloud group based on the linear distance between each point cloud coordinate in each point cloud group and the radar scanner 12.

Taking the first point cloud group PG1 as an example, the processor 11 determines, based on linear distances between point cloud coordinates of each point cloud data entry in the point cloud group and a position of the radar scanner 12, a point cloud coordinate having a minimum linear distance MR and a point cloud coordinate having a maximum linear distance LR. In addition, the processor 11 determines, based on angles between connection lines from each point cloud coordinate in the first point cloud group PG1 to the radar scanner 12 and a horizontal line, a point cloud coordinate having a minimum angle MA and a point cloud coordinate having a maximum angle LA. After determining the four point cloud coordinates, the processor 11 establishes the point cloud-adjusted region of the first point cloud group PG1 using the four point cloud coordinates. The method for establishing the point cloud-adjusted regions of the second point cloud group PG2, the third point cloud group PG3, the fourth point cloud group PG4, and the fifth point cloud group PG5 is the same as the establishment method of the first point cloud group PG1 and is therefore not described herein.

In practical applications, in the adjustment range establishing step S32B, after the processor 11 establishes the point cloud-adjusted region, the processor 11 records one by one the point cloud coordinates and signal parameters of the plurality of point cloud data entries within each point cloud-adjusted region, and records the thresholds corresponding to each point cloud coordinate in the preset threshold table. In the replacement step S33B, the processor 11 modifies, based on the plurality of point cloud data entries within each point cloud-adjusted region, the corresponding preset thresholds to be modified in the preset threshold table. It should be noted that in this embodiment, the processor first establishes the plurality of point cloud-adjusted regions and records a plurality of preset thresholds to be modified, and then, in the replacement step S33B, modifies the plurality of preset thresholds to be modified in the preset threshold table at one time. However, in practice, the processor may also modify a plurality of preset thresholds to be modified in the preset threshold table in batches. In practice, in order to ensure that each preset threshold to be modified has been correctly modified, the processor may first confirm, before the replacement step S33B, whether each point cloud coordinate has been classified into one of the point cloud-adjusted regions, and whether the preset threshold to be modified corresponding to each point cloud coordinate and its coordinate in the preset threshold table have been recorded.

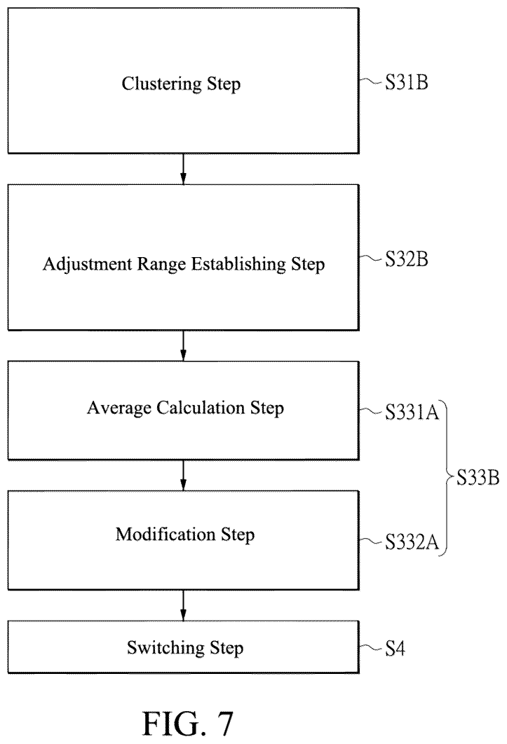

Referring to FIG. 7, which shows a flow chart of the threshold adjustment method according to the fifth embodiment of the present disclosure. The difference between this embodiment and the fourth embodiment lies in that: the replacement step S33B of this embodiment includes the following steps:

An average calculation step S331A: remove outliers from the plurality of signal parameters (for example, the signal strengths) in each point cloud group, and calculate a signal average value using the remaining signal parameters.

A modification step S332A: use the signal average value as the new threshold and, based on the point cloud-adjusted region, modify at least one preset threshold to be modified in the preset threshold table to the new threshold.

It should be noted that, in this embodiment, through the design of first removing outliers among multiple signal parameters in the point cloud group and then calculating the signal average value in the average calculation step S331A, the new threshold in the preset threshold table will not be affected by outliers, thereby avoiding the situation where the new threshold is adjusted to an excessively low or high value.

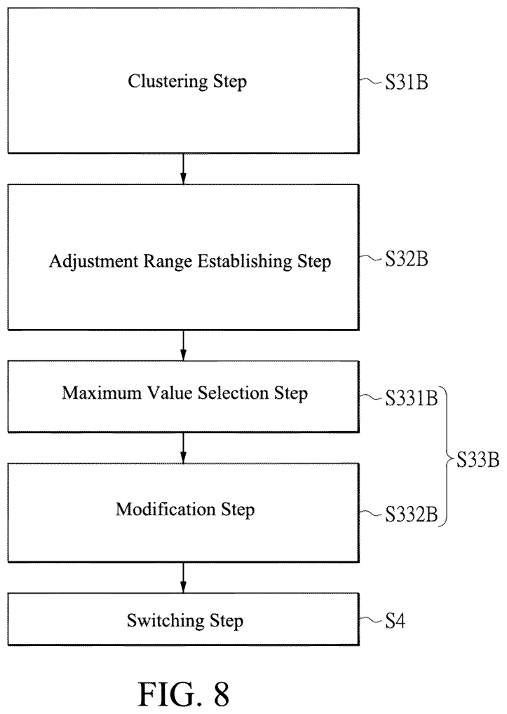

Referring to FIG. 8, which shows a flow chart of the threshold adjustment method according to the sixth embodiment of the present disclosure. The difference between this embodiment and the fourth embodiment lies in that: the replacement step S33B of this embodiment includes the following steps:

A maximum value selection step S331B: select the maximum value among the plurality of signal parameters in each point cloud group as an adjustment threshold.

A modification step S332B: use the adjustment threshold as the new threshold and, based on the point cloud-adjusted region, modify at least one preset threshold to be modified in the preset threshold table to the new threshold.

It is to be noted that, in one preferred embodiment, in the maximum value selection step S331B, outliers among multiple signal parameters in each point cloud group may be removed first, and then the maximum value among the remaining signal parameters may be selected as the adjustment threshold.

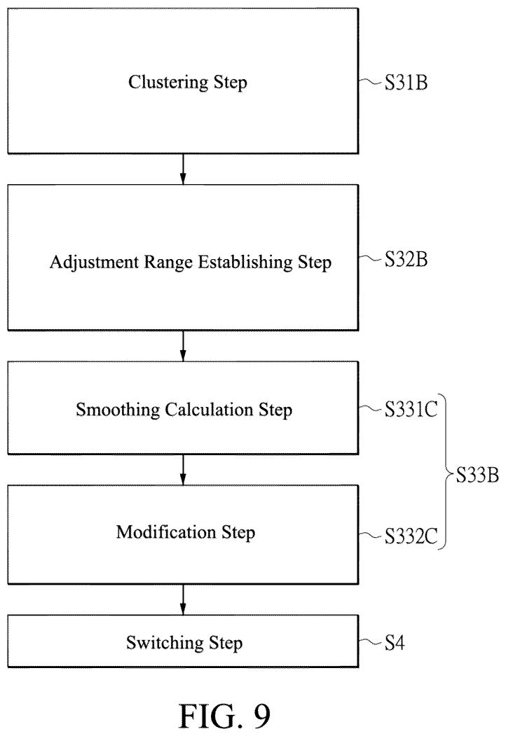

Referring to FIG. 9, which shows a flow chart of the threshold adjustment method according to the seventh embodiment of the present disclosure. The difference between this embodiment and the fourth embodiment lies in that: the replacement step S33B of this embodiment includes the following steps:

A smoothing calculation step S331C: perform a smoothing processing using the plurality of signal strengths in each point cloud group to calculate a smoothing threshold.

A modification step S332C: use the smoothing threshold as the new threshold and, based on the point cloud-adjusted region, modify the plurality of preset thresholds to be modified in the preset threshold table to the new thresholds.

In one practical application, in the smoothing calculation step S331C, Gaussian smoothing may be performed on multiple signal strengths to calculate the smoothing threshold. The performing of Gaussian smoothing on multiple data to calculate smoothed data is known technology and is therefore not described herein.

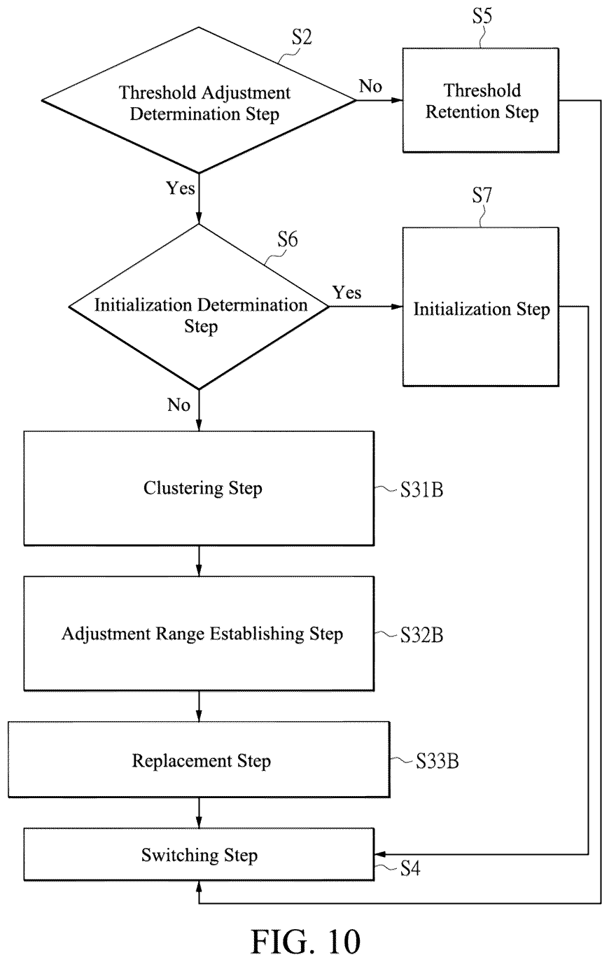

Referring to FIG. 10, which shows a flow chart of the threshold adjustment method according to the eighth embodiment of the present disclosure. The difference between this embodiment and the aforementioned embodiments lies in that: in this embodiment, in the threshold adjustment step S3 (as shown in FIG. 3), after at least one preset threshold in the preset threshold table is modified to a new threshold, the preset threshold table is defined as a modified threshold table. In the threshold adjustment determination step S2, if it is determined that the scanning result corresponds to the preset ignore state, the following steps are executed:

An initialization determination step S6: determine whether an operation time of the processor 11 reaches a preset interval time.

If the operation time reaches the preset interval time, the processor 11 executes the following step:

An initialization step S7: replace the current modified threshold table with the preset threshold table pre-stored in the storage unit.

A switching step S4: cause the radar scanner 12 to switch to the first mode.

In practice, two preset threshold tables may be stored in the storage unit 13. In the threshold adjustment step, the processor 11 will only modify one of the preset threshold tables, and the processor 11 will not modify the other preset threshold table. In the initialization step S7, the processor 11 replaces one preset threshold table with the preset threshold table that has never been modified. That is, in the initialization step S7, the processor 11 updates the preset threshold table that can be modified to the original preset threshold table that has not been modified.

It should be noted that, through the design of the initialization determination step S6, this embodiment can avoid errors resulting from multiple modifications of the thresholds in the preset threshold table. For example, due to weather factors (for example, typhoons) causing significant environmental changes (for example, trees swaying violently), the threshold table will be frequently updated and the thresholds will gradually increase, making it unusable in normal scenarios. Therefore, this embodiment designs the initialization step S7 to enable the threshold table to be used in normal scenarios.

In one variation example, the initialization determination step S6 may also be executed not only after the threshold adjustment determination step S2, but the processor 11 executes the initialization step S7 when its operation time reaches the preset interval time.

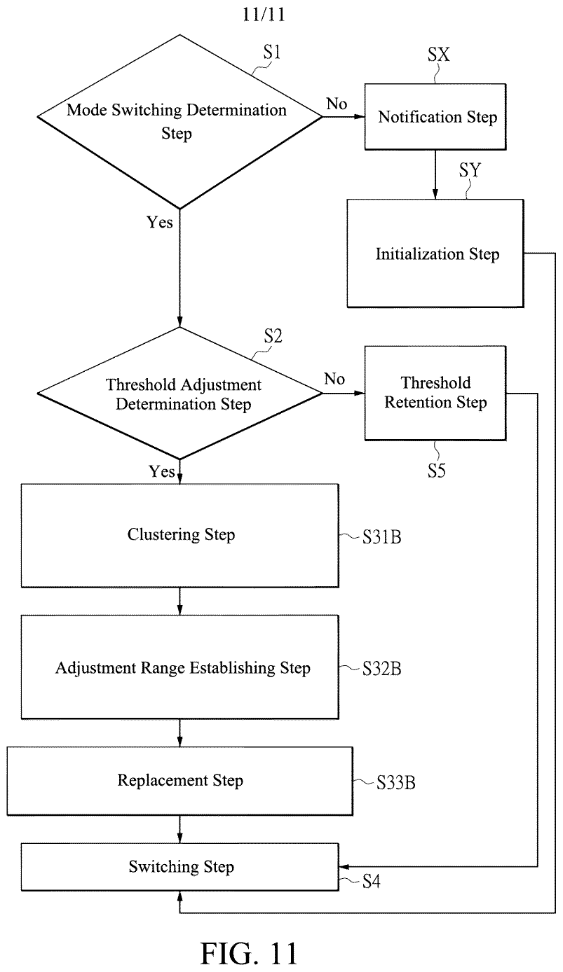

Referring to FIG. 11, which shows a flow chart of the threshold adjustment method according to the ninth embodiment of the present disclosure. The difference between this embodiment and the second embodiment lies in that: in this embodiment, after the notification step SX, the following steps are executed:

An initialization step SY: replace the current modified preset threshold table with the preset threshold table pre-stored in the storage unit 13.

A switching step S4: cause the radar scanner 12 to switch to the first mode.

In this embodiment, in addition to executing the initialization step SY when the operation time of the processor 11 reaches the preset interval time, the initialization step SY is also performed after the notification step SX.

It should be noted that the processing device capable of executing the threshold adjustment method of the present disclosure and the electronic device including the processing device of the present disclosure can be sold, implemented, or manufactured independently.

In view of the above, one beneficial effect of the threshold adjustment method, the processing device, and the electronic device of the present disclosure is that, through the design of the mode switching determination step, the threshold adjustment determination step, and the switching step, can prevent the radar scanner from frequently switching between the first mode and the second mode due to objects that do not need to be tracked. As a result, the overall power consumption of the electronic device is effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A threshold adjustment method executed by a processor of a radar scanning module when a radar scanner of the radar scanning module operates in a second mode, wherein the processor controls the radar scanner to switch between a first mode and the second mode, the radar scanner being configured to scan a preset range to generate a plurality of radar echo data entries, and wherein the processor pre-stores a preset threshold table in a storage unit, the preset threshold table storing a plurality of preset thresholds respectively corresponding to different coordinates within the preset range, the threshold adjustment method comprising:
generating a scanning result based on the plurality of radar echo data entries and at least one of the plurality of preset thresholds, and determining whether the scanning result corresponds to a switching condition;
in response to determining that the scanning result corresponds to the switching condition, determining whether the scanning result corresponds to a preset ignore state;
in response to determining that the scanning result corresponds to the preset ignore state, modifying at least one threshold in the preset threshold table; and
switching the radar scanner to the first mode.

2. The threshold adjustment method according to claim 1, wherein, in response to determining that the scanning result does not correspond to the preset ignore state, the plurality of preset thresholds stored in the preset threshold table are maintained without modification.

3. The threshold adjustment method according to claim 1, wherein generation of the scanning result and determination of whether the scanning result corresponds to a switching condition comprises:
converting the plurality of radar echo data entries into a plurality of point cloud data entries;
establishing an object to be tracked using the plurality of point cloud data entries, and determining whether a movement trajectory of the object to be tracked matches one of a plurality of preset trajectories, so as to determine whether the scanning result corresponds to the switching condition; and
sponse to determining that the movement trajectory does not match one of a plurality of preset trajectories, determining that the scanning result corresponds to the switching condition.

4. The threshold adjustment method according to claim 3, wherein modification of the at least one threshold in the preset threshold table comprises:
modifying the at least one of the plurality of preset thresholds in the preset threshold table to a new threshold; wherein a value of the new threshold is greater than a value of the corresponding preset threshold.

5. The threshold adjustment method according to claim 4, wherein the at least one of the plurality of preset thresholds is plural, and a plurality of coordinates corresponding to the plurality of new thresholds constitute a threshold-adjusted region, and the threshold-adjusted region covers at least a portion of an activity range of the object to be tracked within a preset time period.

6. The threshold adjustment method according to claim 5, wherein, during the determination of whether the scanning result corresponds to the preset ignore state, if a movement distance of the object to be tracked within the preset time period is less than a preset distance, the movement trajectory is determined to correspond to the preset ignore state.

7. The threshold adjustment method according to claim 4, wherein each of the plurality of point cloud data entries comprises at least one point cloud coordinate, and the modification of the at least one of the plurality of preset thresholds to the new threshold comprises:
establishing a point cloud-adjusted region having a preset area by using the point cloud coordinates of the plurality of point cloud data entries; and
modifying, based on the point cloud-adjusted region, at least one preset threshold to be modified in the preset threshold table to the new threshold that is greater than a corresponding original threshold.

8. The threshold adjustment method according to claim 4, wherein each of the plurality of point cloud data entries comprises at least one point cloud coordinate and a signal parameter, and the modification of the at least one of the plurality of preset thresholds to the new threshold comprises:
classifying, based on distances among the plurality of point cloud coordinates, the plurality of point cloud coordinates into a plurality of point cloud groups, wherein linear distances between any two of the point cloud coordinates located in the same point cloud group are less than a preset distance;
establishing a point cloud-adjusted region based on linear distances and angles between each of the plurality of point cloud coordinates in each of the plurality of point cloud groups and the radar scanner, wherein all of the point cloud coordinates in the same point cloud group are located in the same point cloud-adjusted region; and
modifying, based on the point cloud-adjusted region, at least one preset threshold to be modified in the preset threshold table to the new threshold.

9. The threshold adjustment method according to claim 8, wherein the modification of the at least one preset threshold to be modified to the new threshold comprises:
removing outliers from the plurality of signal parameters in each of the plurality of point cloud groups, and calculating a signal average value using remaining ones of the plurality of signal parameters; and
using the signal average value as the new threshold and modifying, based on the point cloud-adjusted region, the at least one preset threshold to be modified in the preset threshold table to the new threshold.

10. The threshold adjustment method according to claim 8, wherein the modification of the at least one preset threshold to be modified to the new threshold comprises:
selecting a maximum value from the plurality of signal parameters in each of the plurality of point cloud groups as an adjustment threshold; and
using the adjustment threshold as the new threshold and modifying, based on the point cloud-adjusted region, the at least one preset threshold to be modified in the preset threshold table to the new threshold.

11. The threshold adjustment method according to claim 8, wherein the at least one preset threshold to be modified is plural, and the modification of the at least one preset threshold to be modified to the new threshold comprises:
performing a smoothing process using signal strengths of the plurality of point cloud data entries in each of the plurality of point cloud groups to calculate a smoothing threshold; and
using the smoothing threshold as the new threshold and modifying, based on the point cloud-adjusted region, the plurality of preset thresholds to be modified in the preset threshold table to the new thresholds.

12. The threshold adjustment method according to claim 8, wherein:
after the at least one of the plurality of preset thresholds in the preset threshold table is modified to the new threshold, the preset threshold table is defined as a modified threshold table; and
during the establishment of the object to be tracked and determination of whether the movement trajectory of the object to be tracked matches one of the plurality of preset trajectories, in response to determining that the movement trajectory of the object to be tracked does not match any of the plurality of preset trajectories, then before the classification of the plurality of point cloud coordinates into the plurality of point cloud groups, the processor executes:
determining whether an operation time of the processor has reached a preset interval;
in response to determining that the operation time has reached the preset interval, replacing the modified threshold table with the preset threshold table pre-stored in the storage unit.

13. The threshold adjustment method according to claim 4, wherein,
after the at least one of the plurality of preset thresholds in the preset threshold table is modified to the new threshold, the preset threshold table is defined as a modified threshold table; and
during the establishment of the object to be tracked and determination of whether the movement trajectory of the object to be tracked matches one of the plurality of preset trajectories, if the movement trajectory of the object to be tracked does not match any of the plurality of preset trajectories, the processor executes:
determining whether an operation time of the processor has reached a preset interval time;
in response to determining that the operation time has reached the preset interval time, replacing the modified threshold table with the preset threshold table pre-stored in the storage unit.

14. The threshold adjustment method according to claim 4, wherein, during the establishment of the object to be tracked and determination of whether the movement trajectory of the object to be tracked matches one of a plurality of preset trajectories, if the movement trajectory of the object to be tracked matches one of the plurality of preset trajectories, the method further comprises:
sending notification information to an image capture device to activate the image capture device; and
replacing the current preset threshold table with the preset threshold table pre-stored in the storage unit.

15. A processing device comprising: a processor capable of executing the threshold adjustment method according to claim 1.

16. An electronic device comprising: a processor and a radar scanner, wherein the processor is capable of executing the threshold adjustment method according to claim 1.
